(19) United States
(12) Patent Application Publication
(10) Pub. No.: US 2026/0087682 A1
(43) Pub. Date: Mar. 26, 2026

(54) ENVIRONMENTAL FUTURE PROJECTOR

(71) Applicant: Toyota Research Institute, Inc., Los Altos, CA (US)

(72) Inventors: Laura A. Libby, San Francisco, CA (US); Nikos Arechiga, San Mateo, CA (US); Nayeli S. Bravo, Palo Alto, CA (US); Candice Hogan, Foster City, CA (US)

(73) Assignees: Toyota Research Institute, Inc., Los Altos, CA (US); Toyota Jidosha Kabushiki Kaisha, Aichi-ken (JP)

(21) Appl. No.: 18/891,800

(22) Filed: Sep. 20, 2024

(51) Int. Cl. G06T 11/00

(52) U.S. Cl. CPC G06T 11/00; G06T 2200/24

(57) ABSTRACT

A method may include receiving a location of a user; receiving behavior information associated with the user; predicting, with a mathematical model, future environment information for the user's location based on the behavior information associated with the user and an assumption that everyone in a particular region has the same behavior information as the user; determining, with a reinforcement learning model, visualizations that are most effective for the user based on the behavior information; and generating, with a generative artificial intelligence model, one or more predicted future images of the environment at the user's location based on the predicted future environment information and the determined visualizations.

### TECHNICAL FIELD

The present specification relates to visualizing environmental future projections.

### BACKGROUND

Human actions can have an effect on the future of the environment. Knowledge about how people's behavior may affect the environment may cause them to change their behavior in more environmentally sustainable ways. However, even if people have a general sense of how their behaviors may affect the environment, this general awareness may not have as much valence as specific visualizations relating to the future environment. Accordingly, a need exists for an environmental future projector.

### SUMMARY

In one embodiment, a method may include receiving a location of a user; receiving behavior information associated with the user; predicting, with a mathematical model, future environment information for the user's location based on the behavior information associated with the user and an assumption that everyone in a particular region has the same behavior information as the user; determining, with a reinforcement learning model, visualizations that are most effective for the user based on the behavior information; and generating, with a generative artificial intelligence model, one or more predicted future images of the environment at the user's location based on the predicted future environment information and the determined visualizations.

In another embodiment, a computing device may include a processor configured to receive a location of a user; receive behavior information associated with the user; predict, with a mathematical model, future environment information for the user's location based on the behavior information associated with the user and an assumption that everyone in a particular region has the same behavior information as the user; determine, with a reinforcement learning model, visualizations that are most effective for the user based on the behavior information; and generate, with a generative artificial intelligence model, one or more predicted future images of the environment at the user's location based on the predicted future environment information and the determined visualizations.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts an illustrative computing network for implementing an environmental future projector, according to one or more embodiments shown and described herein;

FIG. 2 depicts the server computing device of FIG. 1, according to one or more embodiments shown and described herein;

FIG. 3 depicts a flow diagram of an illustrative method of implementing an environmental future projector, according to one or more embodiments shown and described herein;

FIG. 4 depicts a flow diagram of an example method of training a mathematical model, according to one or more embodiments shown and described herein;

FIG. 5 depicts a flow diagram of an example method of training a reinforcement learning model, according to one or more embodiments shown and described herein;

FIG. 6A depicts an example initial image of a user's location, according to one or more embodiments shown and described herein; and

FIG. 6B depicts an example future image of the user's location, according to one or more embodiments shown and described herein.

### DETAILED DESCRIPTION

The embodiments disclosed herein describe an environmental future projector. In particular, a system is disclosed that allows a user to enter information about their current location, demographics and lifestyle. The system may then use a mathematical model to predict how the user's environment would be affected at various points in the future if everyone had the same lifestyle and engaged in the same behaviors as the user.

A reinforcement learning model may use collaborative filtering to predict what types of visualizations are most likely to cause the user to change their behavior in environmentally friendly ways to improve the future environment. A generative artificial intelligence (AI) model may then generate images, based on the predicted future environment and the determined visualizations, of what the user's environment may look like at various points in the future. Presenting such personalized visualizations of the future of the user's environment may encourage the user modify their lifestyle and behaviors to improve the future environment.

The user may also input various behavioral modifications (e.g., changes in lifestyle) and different predicted future images of the user's environment may be generated based on the modified behaviors. Accordingly, the user may be encouraged to modify their behavior in specific ways to improve the future environment. In particular, seeing actual images of their future environment may create a more visceral reaction and have a greater effect on modifying the user's behavior than simply being told about how their current behavior may affect their future environment in a less immersive manner.

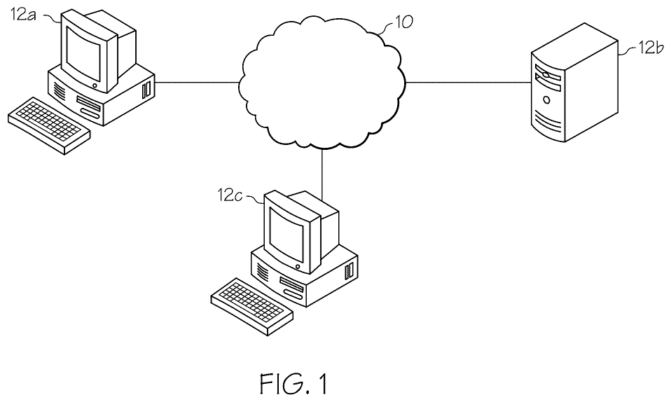

Referring now to the figures, FIG. 1 depicts an illustrative computing network, illustrating components of a system for performing the functions described herein, according to embodiments shown and described herein. As illustrated in FIG. 1, a computer network 10 may include a wide area network, such as the internet, a local area network (LAN), a mobile communications network, a public service telephone network (PSTN) and/or other network and may be configured to electronically connect a user computing device 12a, a server computing device 12b, and an administrator computing device 12c.

The user computing device 12a may be used to input information to be utilized to implement the environmental future projector, as disclosed herein. For example, the user computing device 12a may be a personal computer running software that a user utilizes to input location and behavior information, as disclosed in further detail below. For example, a user may input their location and information about their lifestyle (e.g., information related to the user's carbon footprint). After this information is input into the user computing device 12a, the user computing device 12a or the server computing device 12b may perform the techniques disclosed herein to implement the environmental future projector. In some examples, the user computing device 12a may be a tablet, a smartphone, a smart watch, or any other type of computing device used by a user to input a document to be analyzed.

The administrator computing device 12c may, among other things, perform administrative functions for the server computing device 12b. In the event that the server computing device 12b requires oversight, updating, or correction, the administrator computing device 12c may be configured to provide the desired oversight, updating, and/or correction. The administrator computing device 12c, as well as any other computing device coupled to the computer network 10, may be used to input historical cost data or historical effect size data into a database.

The server computing device 12b may receive information input into the user computing device 12a by a user, and may perform the techniques disclosed herein to implement the environmental future projector. The server computing device 12b may then transmit generated images predicting how the user's environment will look at one or more points in the future to be displayed by the user computing device 12a based on the operations performed by the server computing device 12b. In some examples, the server computing device 12b may be removed from the system of FIG. 1 and may be replaced by a software application on the user computing device 12a. For example, the functions of the server computing device 12b may be performed by software operating on the user computing device 12a. The components and functionality of the server computing device 12b will be set forth in detail below.

It should be understood that while the user computing device 12a and the administrator computing device 12c are depicted as personal computers and the server computing device 12b is depicted as a server, these are non-limiting examples. More specifically, in some embodiments any type of computing device (e.g., mobile computing device, personal computer, server, etc.) may be utilized for any of these components. Additionally, while each of these computing devices is illustrated in FIG. 1 as a single piece of hardware, this is also merely an example. More specifically, each of the user computing device 12a, the server computing device 12b, and the administrator computing device 12c may represent a plurality of computers, servers, databases, etc.

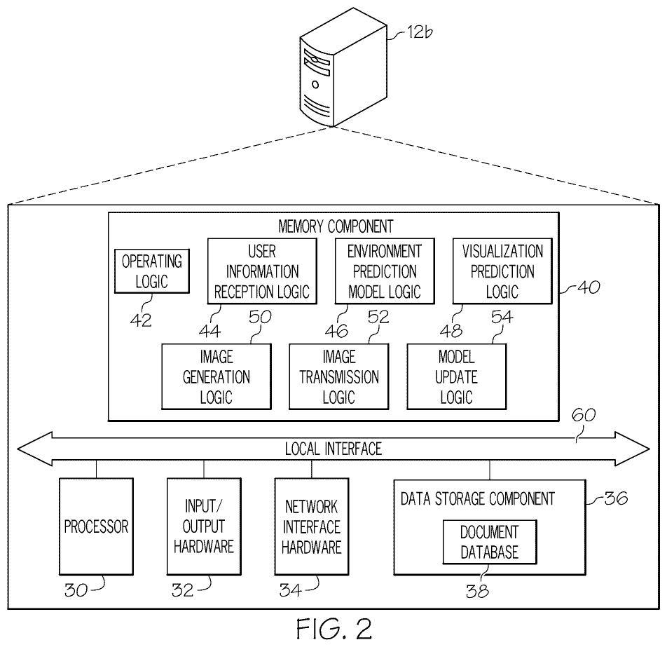

FIG. 2 depicts additional details regarding the server computing device 12b from FIG. 1. While in some embodiments, the server computing device 12b may be configured as a general purpose computer with the requisite hardware, software, and/or firmware, in other embodiments, the server computing device 12b may be configured as a special purpose computer designed specifically for performing the functionality described herein.

As also illustrated in FIG. 2, the server computing device 12b may include a processor 30, input/output hardware 32, network interface hardware 34, a data storage component 36 (which may store model parameters 38), and a non-transitory memory component 40. The memory component 40 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. Additionally, the memory component 40 may be configured to store operating logic 42, user information reception logic 44, environment prediction model logic 46, visualization prediction logic 48, image generation logic 50, image transmission logic 52, and model update logic 54 (each of which may be embodied as a computer program, firmware, or hardware, as an example). A local interface 60 is also included in FIG. 2 and may be implemented as a bus or other interface to facilitate communication among the components of the server computing device 12b.

The processor 30 may include any processing component configured to receive and execute instructions (such as from the data storage component 36 and/or memory component 40). The input/output hardware 32 may include a monitor, keyboard, mouse, printer, camera, microphone, speaker, touch-screen, and/or other device for receiving, sending, and/or presenting data. The network interface hardware 34 may include any wired or wireless networking hardware, such as a modem, LAN port, wireless fidelity (Wi-Fi) card, WiMax card, mobile communications hardware, and/or other hardware for communicating with other networks and/or devices.

It should be understood that the data storage component 36 may reside local to and/or remote from the server computing device 12b and may be configured to store one or more pieces of data for access by the server computing device 12b and/or other components. As illustrated in FIG. 2, the data storage component 36 may store the model parameters 38 of the mathematical model, reinforcement learning model, and generative artificial intelligence model, described in further detail below.

Included in the memory component 40 are the operating logic 42, the user information reception logic 44, the environment prediction model logic 46, the visualization prediction logic 48, the image generation logic 50, the image transmission logic 52, and the model update logic 54. The operating logic 42 may include an operating system and/or other software for managing components of the server computing device 12b.

The user information reception logic 44 may receive user information entered by a user into the user computing device 12a. In order to predict information about the future environment of the user, the server computing device 12b may utilize current data about the user. The user information may include a home address or other location of the user. The user's location may be used to determine information about the user's local environment. The user information reception logic 44 may also receive information about important people in the user's life (e.g., friends and family), such as names, ages, and locations of these people, and the relationships between these people and the user, among other information. The user information may also include demographic information associated with the user, such as the user's age, race, or other demographic information associated with the user.

The user information received by the user information reception logic 44 may also include lifestyle or behavioral information about the user and/or current carbon consumption information associated with the user. For example, the user information may include home energy usage of the user, vehicle type and usage of the user, air travel habits of the user, recycling and composting habits of the user, and the like. In some examples, the user information may include an image of the user's location (e.g., an image of the user's house). In these examples, the server computing device 12b may modify this image to show how predicted environmental change may affect the image (e.g., by adding pollution or fire damage to the image).

As discussed above, a user may enter user information into the user computing device 12a. In some examples, the user computing device 12a may include a user interface that asks the user a series of questions in order to gather this carbon consumption information. In some examples, the user computing device 12a and/or the server computing device 12b may pull user information from other sources. In some examples, the user computing device 12a and/or the server computing device 12b may retrieve user information from publicly available databases (e.g., government records). In some examples, the user computing device 12a and/or the server computing device 12b may retrieve user information from private databases (e.g., from employment records, health records, a user's social media profiles, and the like). After the user computing device 12a receives the user information, either directly from the user or from other sources, the user computing device 12a may transmit the user information to the server computing device 12b. The user information reception logic 44 may cause the server computing device 12b to receive and store the user information.

In some examples, the user information reception logic 44 may retrieve information about the specific address or location of the user (e.g., information about the user's city or neighborhood, or even information about the specific block that the user lives on). This information may include information such as average temperatures of the user's environment, Referring still to FIG. 2, the environment prediction model logic 46 may predict the future environment of the user using a mathematical model, as disclosed herein. As discussed above, the user information reception logic 44 may cause the server computing device 12b to receive user information associated with a user. The environment prediction model logic 46 may then make future predictions about the user's environment based on the received user information, as disclosed herein.

In some examples, the environment prediction model logic 46 may determine carbon consumption or energy usage information about the user based on the behavior information of the user. For example, the user may indicate a type of vehicle that they drive and an amount that they drive the vehicle, and the environment prediction model logic 46 may determine an expected energy usage of the vehicle. In some examples, the environment prediction model logic 46 may access tables or databases that indicate the energy usage or carbon consumption of different behaviors.

In one example, the mathematical model utilized by the environment prediction model logic 46 to predict the future environment of the user may be a machine learning model. For example, a machine learning model may be trained to receive current carbon consumption information for a user and make predictions about the user's future environment based on this information. In other examples, other types of mathematical models may be used by the environment prediction model logic 46 to predict a future environment at the user's location.

Any individual's behavior or carbon consumption is likely to have a minimal effect on the environment. As such, in embodiments, the mathematical model maintained by the server computing device 12b assumes that everyone in a particular region around the user's environment adopts the same behaviors leading to the same carbon footprint as the user. As such, the user's particular behaviors can actually affect the predicted future environment upon the assumption that other people engage in the same behaviors. That is, the server computing device 12b may predict the social collective outcomes of the user's behaviors. In some examples, the mathematical model assumes that everyone in the user's local area (e.g., within the same city as the user) engages in the same behavior as the user. In other examples, the mathematical model assumes that everyone in a larger area surrounding the user (e.g., within the same country as the user) engages in the same behavior as the user. In other examples, the mathematical model assumes that everyone in the world engages in the same behavior as the user.

In one example, the mathematical model maintained by the server computing device 12b is a machine learning model trained using supervised learning techniques and training data comprising historical environmental data. As such, the machine learning model may be trained to receive the carbon consumption information of the user and predict information about the user's future environment assuming everyone has the same carbon consumption data. In other examples, the mathematical model may comprise other types of models. For example, the mathematical model may utilize computer simulations to predict the future environment of the user based on climate models assuming everyone has the same carbon consumption behavior as the user.

In embodiments, the environment prediction model logic 46 may input the user information received by the user information reception logic 44 into the mathematical model maintained by the server computing device 12b. The trained model may then output predicted information about the user's future environment. In particular, the model may output environment information associated with the user's environment at a variety of future time points (e.g., 5 years in the future, 10 years in the future, 20 years in the future, 30 years in the future, and the like). In some examples, the user may specify a particular time period (e.g., 20 years in the future), and the environment prediction model logic 46 may predict environmental information at the user's location for the specified time period.

In some examples, the model may output predicted information about the local environment of the user's location (e.g., the user's neighborhood, block, or house). In other examples, the model may output predicted information about a larger environment around the user's location (e.g., the user's city or state). The model may output a variety of information about the user's predicted future environment, including expected temperature, extreme heat risk, fire risk, flood risk, average rainfall, risks of natural disasters, and the like. The predicted future environment information may be used to generate images of the user's environment, as discussed in further detail below.

Referring still to FIG. 2, the visualization prediction logic 48 may predict the type of visualization that is most likely to cause the user to modify their behavior in environmentally friendly ways, as disclosed herein. As discussed above, the server computing device 12b may generate one or more images showing what the user's environment may look like in the future based on the user's behavior. However, there are a variety of different types of visualizations that may be used to present predicted future images of the user's environment. For example, different visual styles may be used, different geographical ranges may be used (e.g., an image may encompass the user's house, the user's neighbors, the user's block, the user's neighborhood, etc.), different features may be emphasized (e.g., pollution, water levels, fire damage), and the like. Certain visualizations may be more likely than others to cause the user to actual change their behavior to improve their future environment. Accordingly, the visualization prediction logic 48 may predict which types of visualizations of future images of the user's environment or more likely to encourage or cause the user to modify their behavior to improve the future environment, as disclosed herein.

In embodiments, the visualization prediction logic 48 may comprise a reinforcement learning model that may be trained to predict the types of visualizations that are most likely to influence a user to modify their behavior to improve the future environment. The reinforcement learning model may be trained using training data collected from a large number of individuals. In one example, training data may be collected by showing a large number of individuals different types of visualizations indicating predicted future environmental conditions and monitoring their behavior over time. When a person's behavior improves over time (e.g., becomes more environmentally friendly) after being shown a certain type of visualization, the type of visualization shown to the person may receive a positive reward during training of the reinforcement learning model. When a person's behavior does not improve over time in an environmentally friendly manner after being shown a certain type of visualization, the type of visualization shown to the person may be given no reward or a negative reward during training of the reinforcement learning model. As such, over time, the reinforcement learning model may be trained to learn visualizations that are more likely to cause a user to change their behavior in an environmentally friendly way to improve the future environment (e.g., by reducing their energy usage or carbon consumption).

In some examples, instead of monitoring a person's behavior over time, the reinforcement learning model may be trained with other types of training data. For example, different people may be shown different types of visualizations of the future environment and they may then be asked (e.g., via survey questions) how likely the visualization is to affect their behavior. The reinforcement learning model may then be trained based on whether each visualization received a positive or negative response from the user.

In some examples, the reinforcement learning model may use collaborative filtering. For example, the reinforcement learning model may learn different types of visualizations that are more effective at encouraging environmentally friendly behavior by different types of people. For example, the reinforcement learning model may determine N different groups of people and may learn a particular visualization that is most effective in encouraging each group to engage in environmentally friendly behavior. The visualization prediction logic 48 may then determine which of the N groups people is most likely to encourage the user to engage in environmentally friendly behaviors. After this example reinforcement learning model is trained, the visualization prediction logic 48 determines which group of people the user is most similar to, based on the user information received by the user information reception logic 44, and determine that the types of visualizations associated with that group of people.

After being trained, the parameters of the reinforcement learning model may be stored in the data storage component 36. The visualization prediction logic 48 may then use the trained reinforcement learning model to predict the types of visualizations most likely to encourage the user to change their behavior to improve the future environment. In some examples, the visualization prediction logic 48 may determine the types of visualization prompts to be input to a generative AI model, as disclosed in further detail below.

Referring still to FIG. 2, the image generation logic 50 may generate one or more predicted future images of the user's environment, as disclosed herein. In the illustrated example, the image generation logic 50 utilizes a generative AI model to generate one or more predicted future images of the user's environment. A generative AI model may receive a prompt as input and may output content based on the prompt. A text-based generative AI model (e.g., ChatGPT, Gemini) may receive a text prompt as input, and may output a text response. An image-based AI model (e.g., Midjourney, DALL-E) may receive a text prompt as input, and may output an image as a response. Generative AI models may be trained on large data sets to produce a response based on an input prompt. In the illustrated example, the generative AI model maintained by the server computing device 12b may be trained to generate images.

In the illustrated example, the image generation logic 50 may utilize a generative AI model to generate one or more predicted future images of the user's environment based on the user information received by the user information reception logic 44, the environment prediction made by the environment prediction model logic 46, and the prompt or type of prompt generated by the visualization prediction logic 48. For example, the user information reception logic 44 may receive behavioral information about the user, the environment prediction model logic 46 may predict a pollution level at the user's location 10 years in the future, and the visualization prediction logic 48 may generate a prompt to be input to the generative AI model to cause the generative AI model to generate an image of the user's location with the predicted pollution level. The image generation logic 50 may then input the generated prompt into the generative AI model, which may generate an image of what the environment around the user's location (e.g., the area around the user's house) may look like in 10 years with the predicted pollution level.

In some examples, the image generation logic 50 may generate one or more predicted future images of what the environment around friends or family of the user may look like at various points in the future. For example, the user may input a location of a family member, and the image generation logic 50 may generate one or more predicted future images of the environment at the family member's location assuming that everyone engages in the user's behavior. This may allow the user to visualize not only how their behavior affects their environment, but how it may affect the environment of others.

While the above example generates a predicted future image of the user's house with a predicted pollution level, in other examples, images of the user's environment may be generated to indicate any number of environmental conditions. Furthermore, while the above example generates a predicted image of the user's environment 10 years in the future, in other examples, images of the user's environment may be generated at any future time. In some examples, the image generation logic 50 may generate predicted images of the user's environment at multiple points in the future (e.g., in 5 years, 10 years, 15 years, 20 years, 25 years, 30 years, etc.).

In the above example, the image generation logic 50 generates one or more future predicted images of the user's environment. These images may be 2-dimensional or 3-dimensional. However, in some examples, the image generation logic 50 may also generate a text description of what the user's day-to-day life is predicted to be like in the future based on the predicted environment. For example, the image generation logic 50 may input different prompts into a text-based generative AI model to cause the model to output a text description of what the user's life may be like at different points in the future (e.g., average temperatures, average precipitation, risks of extreme heat or natural disasters, and the like).

Referring still to FIG. 2, the image transmission logic 52 may transmit the images and/or text descriptions generated by the image generation logic 50 to the user computing device 12a. The user computing device 12a may receive the generated images and/or text descriptions and display them to the user.

In some examples, the user computing device 12a may include a user interface that allows the user to browse through different images at different time periods. For example, the user interface of the user computing device 12a may receive predicted future images of the user's environment at one-year intervals (e.g., in 1 year, 2 years, 3 years, etc.). In this example, the user computing device 12a may include a user interface that allows the user to browse through the images received by the user computing device 12a so that the user can easily view how their environment may progress as different intervals into the future.

Referring still to FIG. 2, the model update logic 54 may receive updated user information, and may update the models described above with the updated user information, as disclosed herein. In particular, in some examples, the user interface of the user computing device 12a may allow the user to modify the user information after the predicted future images of the user's environment are displayed. For example, the user may view images of their predicted future environment based on their current behavior, as described above. The user may then enter modified behavioral information to see how the predicted future information would change based on the modified behaviors.

For example, the user may initially enter information about the car they currently drive (e.g., a gas-powered vehicle), and predicted future images of the user's environment may be generated on the assumption that everyone drives the same car, using the techniques described above. The user may then enter revised user information indicating that the user drives an electric vehicle. The user computing device 12a may then transmit the modified behavioral information to the server computing device 12b. The model update logic 54 may then cause the environment prediction model logic 46 to generate updated future environment predictions based on the assumption that everyone drives an electric vehicle. The model update logic 54 may then cause the image generation logic 50 to generate updated predicted future images of the user's environment based on the updated future environment predictions. This may allow the user to view one set of images of the future environment under the assumption that everyone drives a gas-powered vehicle, and another set of images of how the future environment would change under the assumption that everyone switches to electric vehicles. This allows the user to see how different behaviors affect the future environment, and may encourage the user to engage in more environmentally friendly behaviors to improve the future environment. In some examples, the user interface of the user computing device 12a may allow the user to view the generated images in augmented reality, or virtual reality or compatible mobile or wearable devices.

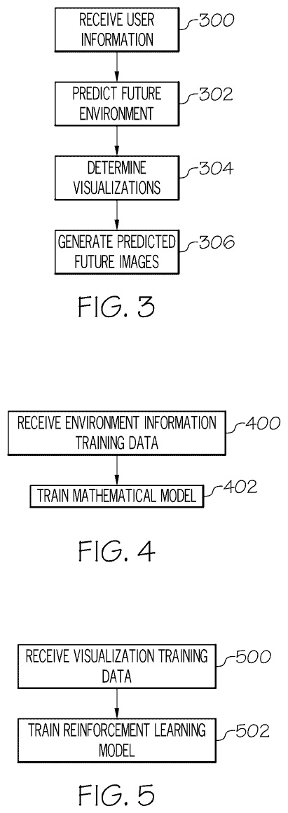

FIG. 3 shows a flowchart of an example method that may be performed by the server computing device 12b to implement an environmental future projector. Although the steps associated with the steps of FIG. 3 will be described as being separate tasks, in other embodiments, the blocks may be combined or omitted.

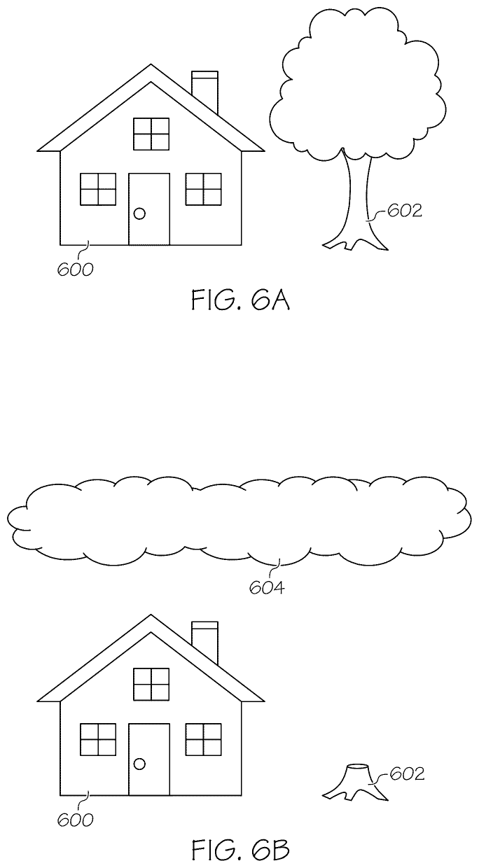

At step 300, the user information reception logic 44 receives user information associated with a user. As discussed above, the user information may include a location of the user and information about current carbon consumption of the user. The user information may include behavior or lifestyle information associated with the user. In some examples, the user information may include a current image of the user's location, as shown in the example of FIG. 6A. In the example of FIG. 6A, the image of the user's location includes the user's house 600 and a tree 602 next to the user's house.

Referring back to FIG. 3, at step 302, the environment prediction model logic 46 predicts future environment information for the user's location. In particular, the environment prediction model logic 46 may utilize a mathematical model to predict future environment information associated with the user's location based on the received location of the user and carbon consumption information of the user, under the assumption that everyone in the world (or everyone in a particular portion of the world, such as the user's country) has the same carbon consumption behavior as the user. The environment prediction model logic 46 may predict future environment information associated with the user's location at a variety of times in the future. In one example, the environment prediction model logic 46 may predict an increase in deforestation and pollution at the user's location at a point in the future.

At step 304, the visualization prediction logic 48 determines visualizations that are most effective for the user. In particular, the visualization prediction logic 48 may determine visualizations that are most likely to cause the user to change their behavior in ways that are likely to improve the future environment. The visualization prediction logic 48 may utilize a reinforcement learning model to determine the most effective types of visualizations based on the received user information. In some examples, the visualization prediction logic 48 generates a prompt that may be entered into a generative artificial intelligence model to generate the appropriate types of visualizations.

At step 306, the image generation logic 50 generates one or more predicted future images of the user's environment. In particular, the image generation logic 50 may utilize a generative artificial intelligence model to generate the one or more predicted future images of the user's environment based on the received of the user and the carbon consumption information of the user. In embodiments, the image generation logic 50 may input a prompt into a generative artificial intelligence model to cause the generative artificial intelligence model to generate one or more predicted future images of the user's environment having the type of visualization determined by the visualization prediction logic 48 and indicating future environmental information predicted by the environment prediction model logic 46. In some examples, the image generation logic 50 may input the prompt determined by the visualization prediction logic 48 into a generative artificial intelligence model. FIG. 6B shows an example of a future image of the user's environment in which future deforestation and pollution is predicted. In particular, in the example of FIG. 6B, the tree 602 next to the user's house 600 has been felled and pollution 604 in the environment is shown.

FIG. 4 shows a flowchart of an example method that may be performed to train the mathematical model maintained by the server computing device 12b, and used by the environment prediction model logic 46 to predict a future environment around the user's location. Although the steps associated with the steps of FIG. 4 will be described as being separate tasks, in other embodiments, the blocks may be combined or omitted.

At step 400, the server computing device 12b, or another computing device used to train the model, may receive environment information training data. The environment information may include carbon consumption information and environment data associated with a plurality of users at a plurality of different locations at a plurality of different time periods. At step 402, the server computing device 12b or another computing device may use supervised learning techniques to train the mathematical model, using the environment information training data, to receive a current location and carbon consumption information, and predict future environment information around the location.

FIG. 5 shows a flowchart of an example method that may be performed to train the reinforcement learning model maintained by the server computing device 12b, and used by the visualization prediction logic 48 to predict visualizations that are most likely to cause users to engage in more environmentally friendly behaviors. Although the steps associated with the steps of FIG. 5 will be described as being separate tasks, in other embodiments, the blocks may be combined or omitted.

At step 500, the server computing device 12b, or another computing device used to train the model, may receive visualization training data. In one examples, the visualization training data may include data indicating different types of visualizations presented to a plurality of users, and how those users changed their behaviors over time after seeing the different types of visualizations. In other examples, the visualization training data may include data indicating different types of visualizations presented to a plurality of users, and survey results indicating how likely different users are to change their behavior after seeing the different types of images. The visualization training data may also include locations and carbon consumption information associated with the users.

At step 502, the server computing device 12b or another computing device may use reinforcement learning techniques to train the reinforcement learning model, using the environment information training data, to receive a current location of a user and carbon consumption information associated with the user, and predict the types of visualizations that are most likely to cause the user to change their behavior in ways likely to improve the future environment. In some examples, the reinforcement learning model may be trained using collaborative filtering.

It should now be understood that embodiments described herein are directed to an environmental future projector. By presenting predicted future images of a user's location indicating how the future environment may be affected by their current behavior using particular visualizations, the user may be encouraged to engage in more environmentally friendly or sustainable behaviors. As such, the future environment may be improved.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
receiving a location of a user;
receiving behavior information associated with the user;
predicting, with a mathematical model, future environment information for the user's location based on the behavior information associated with the user and an assumption that everyone in a particular region has the same behavior information as the user;
determining, with a reinforcement learning model, visualizations that are most effective for the user based on the behavior information; and
generating, with a generative artificial intelligence model, one or more predicted future images of the environment at the user's location based on the predicted future environment information and the determined visualizations.

2. The method of claim 1, wherein the particular region comprises the entire world.

3. The method of claim 1, wherein the location of the user comprises a home address of the user.

4. The method of claim 1, further comprising:
determining carbon usage information of the user based on the behavior information; and
determining the environment information for the user's location based on the carbon usage information of the user.

5. The method of claim 1, further comprising:
determining a second location of a person associated with the user;
predicting, with the mathematical model, future environment information for the second location based on the behavior information associated with the user and the assumption that everyone in the particular region has the same behavior information as the user; and
generating, with the generative artificial intelligence model, one or more predicted future images of the environment at the second location based on the predicted future environment information for the second location and the determined visualizations.

6. The method of claim 1, further comprising:
receiving a specified future time period;
predicting, with the mathematical model, future environment information for the user's location at the specified future time period based on the behavior information associated with the user and the assumption that everyone in the particular region has the same behavior information as the user; and
generating, with the generative artificial intelligence model, one or more predicted future images of the environment at the user's location at the specified future time period based on the predicted future environment information and the determined visualizations.

7. The method of claim 1, wherein the behavior information comprises energy usage of the user.

8. The method of claim 1, wherein the behavior information comprises lifestyle information associated with the user.

9. The method of claim 1, wherein the reinforcement learning model is trained based on training data indicating which types of visualizations have caused users to change their behavior to reduce their carbon consumption.

10. The method of claim 1, wherein the determined visualizations indicate one or more visual styles.

11. The method of claim 1, wherein the determined visualizations indicate different geographic ranges around the user's location.

12. The method of claim 1, wherein the determined visualizations indicate one or more environmental features of the environment at the user's location.

13. The method of claim 1, wherein the reinforcement learning model is trained using collaborative filtering.

14. The method of claim 1, further comprising determining a prompt to cause the generative artificial intelligence model to generate the one or more predicted future images of the environment at the user's location based on the determined visualizations.

15. The method of claim 1, further comprising:
displaying the one or more predicted future images to the user;
receiving revised behavior information associated with the user;
predicting, with the mathematical model, revised future environment information at the user's location on the assumption that everyone in the particular region has the revised behavior information; and
generating, with the generative artificial intelligence model, one or more revised predicted future images of the environment at the user's location based on the revised future environment information, and the determined visualizations.

16. A computing device comprising a processor configured to:
receive a location of a user;
receive behavior information associated with the user;
predict, with a mathematical model, future environment information for the user's location based on the behavior information associated with the user and an assumption that everyone in a particular region has the same behavior information as the user;
determine, with a reinforcement learning model, visualizations that are most effective for the user based on the behavior information; and
generate, with a generative artificial intelligence model, one or more predicted future images of the environment at the user's location based on the predicted future environment information and the determined visualizations.

17. The computing device of claim 16, wherein the processor is further configured to:
determine carbon usage information of the user based on the behavior information; and
determine the environment information for the user's location based on the carbon usage information of the user.

18. The computing device of claim 16, wherein the processor is further configured to:
determine a second location of a person associated with the user;
predict, with the mathematical model, future environment information for the second location based on the behavior information associated with the user and the assumption that everyone in the particular region has the same behavior information as the user; and
generate, with the generative artificial intelligence model, one or more predicted future images of the environment at the second location based on the predicted future environment information for the second location and the determined visualizations.

19. The computing device of claim 16, wherein the processor is further configured to determine a prompt to cause the generative artificial intelligence model to generate the one or more predicted future images of the environment at the user's location based on the determined visualizations.

20. The computing device of claim 16, wherein the processor is further configured to:
display the one or more predicted future images to the user;
receive revised behavior information associated with the user;
predict, with the mathematical model, revised future environment information at the user's location on the assumption that everyone in the particular region has the revised behavior information; and
generate, with the generative artificial intelligence model, one or more revised predicted future images of the environment at the user's location based on the revised future environment information, and the determined visualizations.
